(19) United States
(12) Patent Application Publication
(10) Pub. No.: US 2018/0079765 A1
(43) Pub. Date: Mar. 22, 2018

(54) Double Metal Cyanide Catalyst and Epoxide/Carbon Dioxide Copolymer Prepared Using the Same

(71) Applicants: SK Innovation Co., Ltd., Seoul (KR); SK Global Chemical Co., Ltd., Seoul (KR)

(72) Inventors: Il Gu Jung, Daejeon (KR); Ji Su Jeong, Daejeon (KR); Kodiyan Varghese Jobi, Suwon-si (KR); Jong Chan Kim, Daejeon (KR); Bun Yeoul Lee, Suwon-si (KR); Han Sol Lee, Daejeon (KR); Je Ho Lee, Daejeon (KR); Jeon Koo Lee, Daejeon (KR)

(21) Appl. No.: 15/785,830

(22) Filed: Oct. 17, 2017

Related U.S. Application Data
(62) Division of application No. 14/905,526, filed on Jan. 15, 2016.

(30) Foreign Application Priority Data
Jul. 18, 2013 (KR) 10-2013-0084750
Jul. 11, 2014 (KR) 10-2014-0087428

(51) Int. Cl. C07F 19/00; C08G 64/34; C08G 18/66; B01J 31/12; B01J 31/22; C08G 18/44

(52) U.S. Cl. CPC C07F 19/00; C08G 64/34; C08G 18/44; B01J 31/12; B01J 31/22; C08G 18/664

(57) ABSTRACT

Provided are a double metal cyanide (DMC) catalyst used in copolymerization of an epoxide/carbon dioxide useful for preparing polyurethane, a foaming agent, an elastomer, sealant, a coating material, and the like, and an epoxide/carbon dioxide copolymer prepared using the same.

In addition, the present invention provides a double metal cyanide (DMC) catalyst prepared using an ion-exchange resin without washing alcohol, and an epoxide/carbon dioxide copolymer having a high purity, a high selectivity, and a high carbonate content prepared using the same.

This application is a divisional application of U.S. patent application Ser. No. 14/905,526 filed Jan. 15, 2016. U.S. patent application Ser. No. 14/905,526 is the United States national phase of International Application No. PCT/KR2014/006360 filed Jul. 15, 2014, and claims priority to Korean Patent Application Nos. 10-2013-0084750 and 10-2014-0087428, filed Jul. 18, 2013 and Jul. 11, 2014, respectively. The disclosures of each of these applications are hereby incorporated in their entirety by reference.

### TECHNICAL FIELD

The present invention relates to a double metal cyanide (DMC) catalyst used in a method of preparing a polyol polymer useful for preparing polyurethane, a foaming agent, an elastomer, sealant, a coating material, and the like, and an epoxide/carbon dioxide copolymer having a high carbonate content ratio prepared using the same.

More specifically, the present invention relates to a double metal cyanide (DMC) catalyst prepared using an ion-exchange resin without washing alcohol, and an epoxide/carbon dioxide copolymer having a high purity, a high selectivity, and a high carbonate content prepared using the same.

### BACKGROUND ART

A double metal cyanide (DMC) catalyst is used in preparing a plurality of polymer products including polyether, polyester, and polyetherester polyol, which is known to a person skilled in the art.

The double metal cyanide (DMC) catalyst for a reaction of adding alkylene oxide to a starting compound having active hydrogen atoms is disclosed in, for example, U.S. Pat. No. 3,404,109, U.S. Pat. No. 3,829,505, U.S. Pat. No. 3,941,849 and U.S. Pat. No. 5,158,922. The active catalyst produces polyether polyol having a low degree of unsaturation as compared to similar polyol prepared by a base (KOH) catalyst reaction.

In addition, high-quality polyurethanes (for example, coating, an adhesive, a sealant, an elastomer and a foaming agent) may be formed by processing polyether polyol obtained with the DMC catalyst.

The double metal cyanide (DMC) catalyst is generally prepared by reacting aqueous metal salt solution and aqueous metal cyanide salt solution in the presence of an organic complex ligand, for example, ether.

A typical method of preparing a catalyst includes mixing aqueous zinc chloride (an excessive amount) solution and aqueous potassium hexacyanocobaltate (III) solution and adding dimethoxyethane (glyme) to the formed dispersion solution.

The catalyst is filtered and washed with aqueous glyme solution to obtain an active catalyst represented by the following Chemical Formula:

Zn₃[Co(CN)₆]₂.xZnCl₂.yH₂O.z(glyme)

However, in a case of the double metal cyanide (DMC) catalyst prepared by the reaction above, since the aqueous metal salt solution has significantly low solubility to an organic solvent, the catalyst is prepared using H₂O and washed with an organic solvent several times, which is inconvenient. In addition, since it is difficult to adjust a content of water or alcohol contained in the catalyst, there is a disadvantage in that activities are largely different for each preparation of the catalyst and, thus, there is a limitation in being used commercially.

### DISCLOSURE

### Technical Problem

An object of the present invention is to provide a double metal cyanide (DMC) catalyst capable of preparing an epoxide/carbon dioxide copolymer having a high catalytic activity, and reproducibility by converting a metal cyanide complex salt into a material soluble in alcohol using an ion-exchange resin.

Another object of the present invention is to provide a double metal cyanide (DMC) catalyst capable of preparing an epoxide/carbon dioxide copolymer of which a content is adjustable at a precise ratio, without washing a metal cyanide complex salt.

In addition, another object of the present invention is to provide an epoxide/carbon dioxide copolymer having a high purity, a high selectivity, and a high carbonate content prepared using the double metal cyanide (DMC) catalyst.

### Technical Solution

In one general aspect, an embodiment of the present invention provides a double metal cyanide (DMC) catalyst for preparing an epoxide/carbon dioxide copolymer, represented by the following Chemical Formula (1):

H⁺[M(X)]⁺ₙ[M′(CN)₆]^{m-} Chemical Formula (1)

in the Chemical Formula (1), M is a transition metal, X is an anionic salt, H is hydrogen, M′ is any one metal cation selected from the group consisting of Fe(II), Fe(III), Co(II), Co(III), Cr(II), Cr(III), Ni(II), Rh(III), Ru(II), V(IV), and V(V), n is the same as a charge of M, m=n+1 is satisfied, and n and m are non-zero integers.

X of the Chemical Formula (1) may be any one selected from the group consisting of chloride, bromide, iodide, hydroxide, sulfate, carbonate, cyanide, oxalate, thiocyanate, isothiocyanate, carboxylate, and nitrate.

The double metal cyanide (DMC) catalyst may be coordinated with an organic solvent or water.

The organic solvent coordinated on the double metal cyanide (DMC) catalyst may be C₁ to C₇ alkyl alcohol.

In another general aspect, an embodiment of the present invention provides a method of preparing the double metal cyanide (DMC) catalyst as described above, the method including: ion-exchanging a metal cyanide complex salt by an ion-exchange resin; separating the ion-exchanged metal cyanide complex salt; and reacting the separated and ion-exchanged metal cyanide complex salt with a metal salt in the presence of an organic solvent.

The metal cyanide complex salt may be represented by the following Chemical Formula (2), and the metal salt may be represented by the following Chemical Formula (3):

YₐM′(CN)_{b}(A)_{c} Chemical Formula (2)

in the Chemical Formula (2), M′ is any one metal cation selected from the group consisting of Fe(II), Fe(III), Co(II), Co(III), Cr(II), Cr(III), Ni(II), Rh(III), Ru(II), V(IV) and V(V), Y is an alkali metal ion or an alkaline earth metal ion, A is an anionic salt, both of a and b are an integer of 1 or more, and the sum of charges of a, b, and c is the same as a charge of M′, and

M(X)ₙ Chemical Formula (3)

in the Chemical Formula (3), M is a transition metal, X is an anionic salt, and n is an integer as the same as a charge of M.

X of the Chemical Formula (3) may be any one selected from the group consisting of chloride, bromide, iodide, hydroxide, sulfate, carbonate, cyanide, oxalate, thiocyanate, isothiocyanate, carboxylate, and nitrate.

The metal cyanide complex salt may be potassium hexacyanocobaltate (III), and the metal salt is zinc chloride (II), zinc chloride (III), zinc bromide or zinc iodide.

The method may further include: removing the organic solvent by distillation.

In another general aspect, an embodiment of the present invention provides a method of preparing an epoxide/carbon dioxide copolymer including: reacting epoxide and carbon dioxide in the presence of the double metal cyanide (DMC) catalyst as described above.

The epoxide/carbon dioxide copolymer may have a number average molecular weight of 500 to 500,000, and a carbonate molar ratio of 0.05 to 0.70.

An embodiment of the present invention provides a method of preparing an epoxide/carbon dioxide copolymer including: containing a chain transfer agent in epoxide and carbon dioxide to react with each other in the presence of the double metal cyanide (DMC) catalyst represented by the Chemical Formula (1).

An embodiment of the present invention provides a method of preparing an epoxide/carbon dioxide copolymer having a number average molecular weight of 500 to 200,000 and a carbonate molar ratio of 0.05 to 0.70, including: containing a chain transfer agent in epoxide and carbon dioxide to react with each other in the presence of the double metal cyanide (DMC) catalyst represented by the Chemical Formula (1).

The chain transfer agent may be represented by the following Chemical Formula (4):

J(LH)_{d} Chemical Formula (4)

in the Chemical Formula (4), J is C₁ to C₆₀ hydrocarbyl with or without an ether group, an ester group, or an amine group; L is —O or —CO₂; d is an integer of 1 to 10; and when d is 2 or more, L is the same as each other or different from each other.

In the Chemical Formula (4), d may be 2 and J may be —(CH)ₙ— or 4,8-bis(hydroxymethyl)tricyclo[5.2.1.0]decane (wherein n is an integer of 1 to 20).

In another general aspect, an embodiment of the present invention provides an epoxide/carbon dioxide copolymer having a number average molecular weight of 40,000 to 80,000, and a carbonate molar ratio of 0.50 to 0.70, prepared by reacting epoxide and carbon dioxide in the presence of the double metal cyanide (DMC) catalyst as described above.

In addition, an embodiment of the present invention provides an epoxide/carbon dioxide copolymer having a number average molecular weight of 1,400 to 13,000, and a carbonate molar ratio of 0.50 to 0.70, prepared by further containing the chain transfer agent in epoxide and carbon dioxide in the presence of the double metal cyanide (DMC) catalyst as described above.

### Advantageous Effects

According to the present invention, the double metal cyanide (DMC) catalyst capable of preparing the epoxide/carbon dioxide copolymer having a highly secured catalytic reproducibility and being commercially and economically prepared by a simple process may be provided.

In addition, the epoxide/carbon dioxide copolymer having a high purity, a high selectivity, and a high carbonate content may be provided using the double metal cyanide (DMC) catalyst prepared by the method of the present invention.

### DESCRIPTION OF DRAWINGS

The above and other objects, features, and advantages of embodiments of the present invention will become apparent from the following description of preferred embodiments given in conjunction with the accompanying drawings, in which:

FIG. 1 shows an X-ray diffraction pattern of H⁺[ZnCl]⁺₂[Co(CN)₆]³⁻[CH₃OH] which is an example of a double metal cyanide (DMC) catalyst prepared by embodiment of the present invention.

FIG. 2 shows (a) ¹³C NMR spectrum of propylene oxide, (b) ¹³C NMR spectrum of poly (propylene carbonate), (c) ¹³C NMR spectrum of a high molecular weight of polypropylene carbonate-propylene oxide), and (d) ¹³C NMR spectrum of a low molecular weight of poly(propylene carbonate-propylene oxide)-diol prepared by containing 1,10-decanediol.

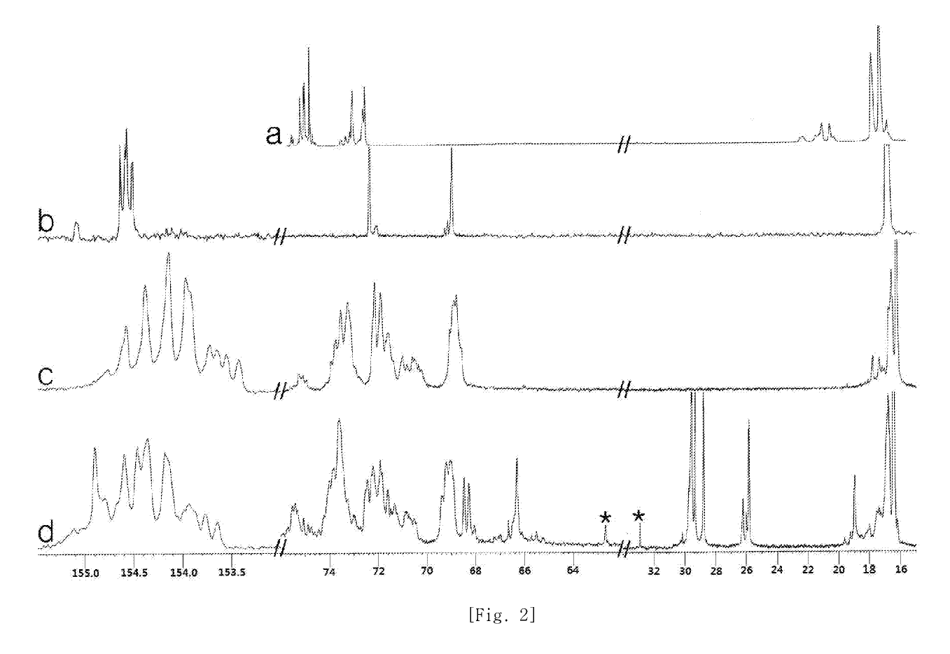

### BEST MODE

Hereinafter, a technical idea of the present invention will be described in more detail with reference to the accompanying drawings and examples. However, the present invention is not limited to the accompanying drawings and the following examples, and it will be apparent to those skilled in the art that various modification and changes may be made without departing from the scopes and spirits of the present invention.

In addition, the drawings and the examples to be described below are provided by way of example so that the idea of the present invention can be sufficiently transferred to those skilled in the art to which the present invention pertain. Therefore, the present invention is not limited to the drawings and examples set forth herein but may be specified in many different forms.

Here, unless technical and scientific terms used herein are defined otherwise, they have meanings understood by those skilled in the art to which the present invention pertains. Known functions and components which obscure the description and the accompanying drawings of the present invention with unnecessary detail will be omitted.

An embodiment of the present invention provides a double metal cyanide (DMC) catalyst for preparing an epoxide/carbon dioxide copolymer, represented by the following Chemical Formula (1):

H⁺[M(X)]⁺ₙ[M′(CN)₆]^{m-} Chemical Formula (1)

in the Chemical Formula (1), M is a transition metal, X is an anionic salt, H is hydrogen, M′ is any one metal cation selected from the group consisting of Fe(II), Fe(III), Co(II), Co(III), Cr(II), Cr(III), Ni(II), Rh(III), Ru(II), V(IV), and V(V), n is the same as a charge of M, m=n+1 is satisfied, and n and m are non-zero integers.

In the Chemical Formula (1), X may be an anionic salt, include all anionic salts achieving the object of the present invention, and may be any one selected from the group consisting of chloride, bromide, iodide, hydroxide, sulfate, carbonate, cyanide, oxalate, thiocyanate, isothiocyanate, carboxylate, and nitrate, but the present invention is not limited thereto.

The double metal cyanide (DMC) catalyst for preparing the epoxide/carbon dioxide copolymer according to an embodiment of the present invention may have a novel catalyst structure containing H⁺ as shown in the Chemical Formula (1), and the double metal cyanide (DMC) catalyst for preparing the epoxide/carbon dioxide copolymer according to an embodiment of the present invention may be prepared by all methods induced to produce the structure of the Chemical Formula (1).

As a non-limited example thereof, an embodiment of the present invention provides the double metal cyanide (DMC) catalyst for preparing the epoxide/carbon dioxide copolymer, prepared by ion-exchanging a metal cyanide complex salt by an ion-exchange resin; separating the ion-exchanged metal cyanide complex salt; and reacting the separated and ion-exchanged metal cyanide complex salt with a metal salt in the presence of an organic solvent, wherein the double metal cyanide (DMC) catalyst may be represented by the Chemical Formula (1).

In order to prepare the double metal cyanide (DMC) catalyst represented by the Chemical Formula (1), the metal cyanide complex salt may be ion-exchanged with the ion-exchange resin.

Therefore, the metal cyanide complex salt may include all complex salts which are capable of being cation-exchanged by the ion-exchange resin, being soluble in the organic solvent, and preparing the double metal cyanide (DMC) catalyst.

As a non-limited example thereof, the metal cyanide complex salt may be represented by the following Chemical Formula (2):

YₐM′(CN)_{b}(A)_{c} Chemical Formula (2)

In the Chemical Formula (2), M′ may be selected from the group consisting of Fe(II), Fe(III), Co(II), Co(III), Cr(II), Cr(III), Mn(II), Mn(III), Ir(III), Ni(II), Rh(III), Ru(II), V(IV), and V(V).

More preferably, M′ may be selected from the group consisting of Co(II), Co(III), Fe(II), Fe(III), Cr(II), Ir(III), and Ni(II).

In the Chemical Formula (2), Y may be hydrogen, an alkali metal ion, or alkaline earth metal ion, and when Y is hydrogen, immersing of the metal cyanide complex salt in the ion-exchange resin may not be necessarily performed.

That is, the double metal cyanide (DMC) catalyst for preparing the epoxide/carbon dioxide copolymer according to an embodiment of the present invention needs to contain H⁺ as shown in the Chemical Formula (1) and, to this end, in a case where Y of the Chemical Formula (2) is an alkali metal ion or alkaline earth metal ion, the ion-exchange may be performed by a cation-exchange resin, but is not limited thereto, and thus, Y of the Chemical Formula (2) may be converted to H⁺ by other methods.

In addition, the double metal cyanide (DMC) catalyst for preparing the epoxide/carbon dioxide copolymer according to an embodiment of the present invention may be coordinated with an organic solvent or water.

The organic solvent may include all organic solvents achieving the object of the present invention, and as a non-limited example thereof, may be normal hexane, dichloroethylene, dichloroethane, methanol, carbon tetrachloride, acetone, o-dichlorobenzene, carbon sulfide, methyl acetate, xylene, chlorobenzene, chloroform, tetrachloroethane, tetrachloroethylene, toluene, and trichloroethylene, preferably, C₁ to C₇ alkyl alcohol, more preferably, methanol, but the present invention is not limited thereto.

In the Chemical Formula (2) according to an embodiment of the present invention, A may be an anionic salt and may include all anionic salts achieving the object of the present invention, and as a non-limited example thereof, may be any one selected from the group consisting of chloride, bromide, iodide, hydroxide, sulfate, carbonate, cyanide, oxalate, thiocyanate, isothiocyanate, carboxylate, and nitrate.

In addition, a and b of the Chemical Formula (2) may be an integer of 1 or more, and the sum of charges of a, b, and c may be the same as a charge of M′.

As described above, the metal cyanide complex salt may include all ranges capable of achieving the object of the present invention, preferably, may be potassium hexacyanocobaltate(III), potassium hexacyanoferrate(II), potassium hexacyanoferrate (III), calcium hexacyanoferrate(III), lithium hexacyanoiridate(III), and the like, more preferably, alkali metal hexacyanocobaltate, but the present invention is not limited thereto.

The metal salt according to an embodiment of the present invention may include all metal salts capable of preparing the double metal cyanide (DMC) catalyst according to the Chemical Formula (1) using the ion-exchanged metal cyanide complex salt by the ion-exchange resin in the presence of the organic solvent.

As a non-limited example thereof, the metal salt may be represented by the following Chemical Formula (3):

M(X)ₙ Chemical Formula (3)

in the Chemical Formula (3), M is a transition metal and, preferably, is selected from the group consisting of Zn(II), Fe(II), Ni(II), Mn(II), Co(II), Sn(II), Pb(II), Fe(III), Mo(IV), Mo(VI), Al(III), V(V), V(IV), Sr(II), W(IV), W(VI), Cu(II), and Cr(III). More preferably, M may be selected from the group consisting of Zn(II), Fe(II), Co(II), and Ni(II).

In the Chemical Formula (3), X may be an anionic salt and may include all anionic salts achieving the object of the present invention and, preferably, may be any one selected from the group consisting of chloride, bromide, iodide, hydroxide, sulfate, carbonate, cyanide, oxalate, thiocyanate, isothiocyanate, carboxylate, and nitrate, and n satisfies a valence state of M.

Examples of the appropriate metal salts may include zinc chloride (II), zinc chloride (III), zinc bromide, zinc acetate, zinc acetylacetonate, zinc benzoate, zinc nitrate, iron sulfate (II), iron bromide (II), cobalt chloride (II), cobalt (II) thiocyanate, nickel formate (II), nickel nitrate (IT), and the like, and mixtures thereof, but the present invention is not limited thereto, wherein zinc chloride (II) is the most preferred.

The ion-exchange resin according to an embodiment of the present invention includes all cation-exchange resins capable of exchanging cations of the metal cyanide complex salt. As a non-limited example thereof, the ion-exchange resin may include a gel type, a porous type, and the like, but the present invention is not limited thereto.

In addition, the ion-exchange resin may be re-used by being washed with an aqueous sulfuric acid solution.

In the method of preparing the double metal cyanide (DMC) catalyst according to an embodiment of the present invention, the metal cyanide complex salt may be ion-exchanged by the ion-exchange resin, and a filtrate may be re-immersed in the ion-exchange resin in order to promote the complete exchange of the cations.

The number of re-immersing is not limited, and as a non-limited example thereof, the number thereof may be 2 to 5, preferably, 3 to 5.

The double metal cyanide (DMC) catalyst according to an embodiment of the present invention may be provided with separate apparatuses for separating the ion-exchanged metal cyanide complex salt by the ion-exchange resin from the filtrate.

The separate apparatus may include all types achieving the object of the present invention, and as a non-limited example thereof, may include a rotary evaporator, but the present invention is not limited thereto.

The cation-exchanged metal cyanide complex salt separated from the filtrate is preferably maintained in a dry condition.

The double metal cyanide (DMC) catalyst according to an embodiment of the present invention may be prepared by reacting the ion-exchanged metal cyanide complex salt separated from the filtrate with the metal salt in the presence of the organic solvent.

The organic solvent may include solvents capable of dissolving the ion-exchanged metal cyanide complex salt which is ion-exchanged by the ion exchange resin and separated from the filtrate, and as a non-limited example thereof, may be C₁ to C₇ alkyl alcohol, but the present invention is not limited thereto.

As compared to a double metal cyanide (DMC) catalyst prepared by the existing method of preparing the DMC catalyst, the double metal cyanide (DMC) catalyst for preparing the epoxide/carbon dioxide copolymer according to an embodiment of the present invention may easily adjust a content of water or alcohol and have a low sensitivity depending on preparation conditions to thereby be commercially and easily prepared with high reproducibility.

That is, when separating a precipitate by filtration with the existing double metal cyanide (DMC) catalyst, a particle size of the precipitate is very small, which is not efficient, and a process of separating the precipitate by centrifugation is needed, such that there is a problem in mass production. However, the double metal cyanide (DMC) catalyst according to an embodiment of the present invention is mass-produced without performing the separation process, which is significantly and commercially useful.

With the double metal cyanide (DMC) catalyst according to an embodiment of the present invention, when the metal cyanide complex salt which is a reactant is potassium hexacyanocobaltate (III) and the metal salt is zinc chloride (II) or zinc chloride (III), white hydrogen chloride may be precipitated.

When zinc chloride (III) is used as the metal salt, solid residue may be washed by an aprotic solvent.

The aprotic solvent may include all solvents achieving an object of removing the solid residue, and as a non-limited example thereof, may be any one selected from the group consisting of diethyl ether, tetrahydrofuran, perfluorohexane, pentane, hexane, cyclohexane, t-butyl methyl ether, acetone, dimethyl sulfoxide, propylene carbonate, and toluene.

When the epoxide/carbon dioxide copolymer is prepared by using the double metal cyanide (DMC) catalyst prepared by an embodiment of the present invention as described above, the epoxide/carbon dioxide copolymer containing a high purity, a high selectivity, and a high carbonate content may be prepared.

In addition, an embodiment of the present invention provides a method of preparing the double metal cyanide (DMC) catalyst as described above.

That is, an embodiment of the present invention provides a method of preparing the double metal cyanide (DMC) catalyst, including ion-exchanging the metal cyanide complex salt by the ion-exchange resin; separating the ion-exchanged metal cyanide complex salt; and reacting the separated and ion-exchanged metal cyanide complex salt with the metal salt in the presence of an organic solvent.

In addition, in the method of preparing the double metal cyanide (DMC) catalyst, the metal cyanide complex salt may be represented by the Chemical Formula (2), and the metal salt may be represented by the Chemical Formula (3), but the present invention is not limited thereto.

As a non-limited example thereof, in the method of preparing the double metal cyanide (DMC) catalyst according to an embodiment of the present invention, the metal cyanide complex salt may be potassium hexacyanocobaltate (III), and the metal salt may be zinc chloride (II), zinc chloride (III) zinc bromide, or zinc iodide.

The method of preparing the double metal cyanide (DMC) catalyst according to an embodiment of the present invention may further include, after the reacting of the separated and ion-exchanged metal cyanide complex salt with the metal salt in the presence of the organic solvent, removing the organic solvent by distillation.

That is, an embodiment of the present invention provides the method of preparing the double metal cyanide (DMC) catalyst represented by the Chemical Formula (1) further including the removing of the organic solvent by distillation.

When the epoxide/carbon dioxide copolymer is prepared in the presence of the double metal cyanide (DMC) catalyst prepared by the above-described method, the epoxide/carbon dioxide copolymer having a high carbonate content ratio may be prepared.

Accordingly, an embodiment of the present invention provides the method of preparing the epoxide/carbon dioxide copolymer including the reacting of epoxide and carbon dioxide in the presence of the double metal cyanide (DMC) catalyst represented by the Chemical Formula (1).

The epoxide/carbon dioxide copolymer prepared as described above may have a high carbonate content ratio, and as a non-limited example thereof, the carbonate content ratio may be 0.05 to 0.70, preferably, 0.50 to 0.67, more preferably, 0.57 to 0.67.

In addition, the epoxide/carbon dioxide copolymer according to an embodiment of the present invention may have a number average molecular weight of 500 to 500,000, preferably, 10,000 to 100,000, more preferably, 40,000 to 80,000, but the present invention is not limited thereto.

As a non-limited example thereof, an embodiment of the present invention provides a method of preparing an epoxide/carbon dioxide copolymer having a number average molecular weight of 500 to 500,000, and a carbonate molar ratio of 0.05 to 0.70, including the reacting of epoxide and carbon dioxide in the presence of the double metal cyanide (DMC) catalyst represented by the Chemical Formula (1).

In addition, an embodiment of the present invention provides an epoxide/carbon dioxide copolymer having a number average molecular weight of 40,000 to 80,000, and a carbonate molar ratio of 0.50 to 0.70, prepared by reacting epoxide and carbon dioxide in the presence of the double metal cyanide (DMC) catalyst represented by the Chemical Formula (1).

The epoxide is a three-membered ring, may be prepared by alkene epoxidation, and may include all materials forming the epoxide/carbon dioxide copolymer by being reacted with carbon dioxide in the presence of the double metal cyanide (DMC) catalyst.

As a non-limited example, the epoxide compound may be at least one selected from the group consisting of a group consisting of (C₂-C₂₀)alkylene oxide unsubstituted or substituted with halogen, (C₁-C₂₀)alkyloxy, (C₆-C₂₀)aryloxy or (C₆-C₂₀)ar(C₁-C₂₀)alkyloxy; (C₄-C₂₀)cycloalkylene oxide unsubstituted or substituted with halogen, (C₁-C₂₀)alkyloxy, (C₆-C₂₀) aryloxy or (C₆-C₂)ar(C₁-C₂₀)alkyloxy; and (C₈-C₂₀) styrene oxide unsubstituted or substituted with halogen, (C₁-C₂₀)alkyloxy, (C₆-C₂₀) aryloxy, (C₆-C₂₀) ar (C₁-C₂₀)alkyl(aralkyl)oxy or (C₁-C₂₀)alkyl.

More specifically, the epoxide may be ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrine, epichlorohydrine, epibromohydrine, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxidenorbornene, limonene oxide, dieldrin, 2,3-epoxidepropylbenzene, styrene oxide, phenylpropylene oxide, stilbene oxide, chlorostilbene oxide, dichlorostilbene oxide, 1,2-epoxy-3-phenoxypropane, benzyloxymethyl oxirane, glycidyl-methylphenyl ether, chlorophenyl-2,3-epoxidepropyl ether, epoxypropyl methoxyphenyl ether, biphenyl glycidyl ether, glycidyl naphthyl ether, and the like, but the present invention is not limited thereto. Preferably, the epoxide may be propylene oxide or ethylene oxide.

In addition, in addition to the epoxide, a reaction solvent may be further added as needed. The reaction solvent may be nearly all polar solvents, and as a non-limited example thereof, may be acetone, methyl ethyl ketone, ethyl acetate, dichloromethane, chloroform, methyl acetate, acetonitrile, tetrahydrofuran, dioxane, and the like. However, the present invention is not limited thereto.

In the epoxide/carbon dioxide copolymer prepared by the existing double metal cyanide (DMC) catalyst, the carbonate content ratio is low as 50% or less. However, the epoxide/carbon dioxide copolymer prepared in the presence of the double metal cyanide (DMC) catalyst containing H⁺ prepared according to an embodiment of the present invention may increase the carbonate molar ratio.

In addition, an embodiment of the present invention provides a method of preparing an epoxide/carbon dioxide copolymer, further including: containing a chain transfer agent in the epoxide and the carbon dioxide to react with each other in the presence of the double metal cyanide (DMC) catalyst represented by the Chemical Formula (1).

The chain transfer agent protonates an end group of a unique chain-growth copolymer and separates the protonated end group from the center of the double metal cyanide (DMC) catalyst, and provides a preparation capability useful for forming urethane.

In the epoxide/carbon dioxide copolymer prepared by further containing the chain transfer agent, the carbonate molar ratio may be 0.05 to 0.70, preferably, 0.57 to 0.67, and the number average molecular weight may be 500 to 200,000, preferably, 1,400 to 13,000, but the present invention is not limited thereto.

As an example thereof, an embodiment of the present invention provides a method of preparing an epoxide/carbon dioxide copolymer having a number average molecular weight of 500 to 200,000, and a carbonate molar ratio of 0.05 to 0.70, including the reacting of epoxide, carbon dioxide, and the chain transfer agent in the presence of the double metal cyanide (DMC) catalyst represented by the Chemical Formula (1).

In addition, an embodiment of the present invention provides an epoxide/carbon dioxide copolymer having a number average molecular weight of 1,400 to 13,000, and a carbonate molar ratio of 0.50 to 0.70, prepared by further containing the chain transfer agent in epoxide and carbon dioxide in the presence of the double metal cyanide (DMC) catalyst represented by the Chemical Formula (1).

The chain transfer agent according to an embodiment of the present invention may include all materials achieving the object of the present invention, and as a non-limited example thereof, may be a compound represented by the following Chemical Formula (4), but is not limited thereto:

J(LH)_{d} Chemical Formula (4)

in the Chemical Formula (4), J is C₁ to C₆₀ hydrocarbyl with or without an ether group, an ester group, or an amine group; L is —O or —CO₂; d is an integer of 1 to 10; and when d is 2 or more, L is the same as each other or different from each other.

Here, one or two or more different kinds of chain transfer agents according to the Chemical Formula (4) may be mixed with each other.

As a non-limited example, in the Chemical Formula (4), d may be 2, J may be —(CH)ₙ— or 4,8-bis(hydroxymethyl)tricyclo[5.2.1.0]decane, wherein n may be an integer of 1 to 20.

As an example thereof, in the Chemical Formula (4), when L is —O, d is 2, and J is —(CH)ₙ— the chain transfer agent according to an embodiment of the present invention may be diol containing two hydroxyl groups, and when L is —CO₂, d is 2 and J is —(CH)ₙ—, the chain transfer agent according to an embodiment of the present invention may be dicarboxylic acid containing two carboxylic acid functional groups.

The dicarboxylic acid may be selected from the group consisting of adipic acid, glutaric acid, succinic acid, malonic acid, terephthalic acid, tricarballyic acid and 1,2,3,4-butanetetracarboxylic acid, and sebacic acid, but the present invention is not limited thereto.

The chain transfer agent according to an embodiment of the present invention may have an effect on a number average molecular weight, a molecular weight distribution, a carbonate content ratio, and the like, of the epoxide/carbon dioxide copolymer prepared depending on the kind thereof.

As an example of an embodiment of the present invention, a copolymer represented by the following Chemical Formula (7) may be prepared by reacting propylene oxide and carbon dioxide in the presence of the double metal cyanide (DMC) catalyst represented by the Chemical Formula (1) for preparing the propylene oxide/carbon dioxide copolymer:

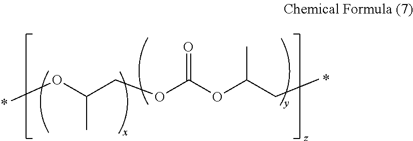

in the Chemical Formula (7), x, y, and z are the number of repeat unit moles and each independently an integer of 1 or more, and y/x+y is 0.57 to 0.67.

The epoxide/carbon dioxide copolymer prepared according to an embodiment of the present invention may form a polyurethane polymer together with isocyanate, a catalyst, and other components.

Hereinafter, in the double metal cyanide (DMC) according to an embodiment of the present invention, exemplary embodiments as to preparation of the double metal cyanide (DMC) catalyst using potassium hexacyanocobaltate (III) which is one kind of the metal cyanide complex salt and a method of preparing poly(propylene carbonate-propylene oxide)-diol using the same will be described.

The following Examples are described by way of example, and those skilled in the art will appreciate that the technical idea of the present invention is not limited by the Examples.

### [Example 1] Preparation of H₃Co(CN)₆ from Potassium Hexacyanocobaltate(III)

5 g(15 mmol) of potassium hexacyanocobaltate(III) was dissolved in 15 ml of distilled water and was immersed in 140 g of an ion-exchange resin (Dowex 5×4-200), and then was filtered after 3 hours. The filtrate of the ion-exchange resin was subjected to re-immersion in the ion-exchange resin about four times, and it was confirmed that K⁺ ions were completely exchanged with H⁺ ions. The filtrated ion-exchange resin may be re-used by washing the resin by 2-normal concentration of aqueous sulfuric acid solution. H₃Co(CN)₆ was separated from the filtrate by a rotary evaporator, and kept in a vacuum desiccator under P₂O₅ for 12 hours, to remove residual water. It was confirmed that the metal cyanide complex salt passing through the ion-exchange resin from which water is removed was H₃Co(CN)₆.0.5H₂O by titration of NaOH standard solution.

### [Example 2] Preparation 1 of DMC Catalyst from H₃Co(CN)₆

2 equivalent of zinc chloride (2.94 g, 0.021 mol) dissolved in 15 ml of methanol was dropwise added to H₃Co(CN)₆.0.5H₂O (2.45 g, 0.010 mol) dissolved in 90 ml of methanol. The reaction mixture was stirred under nitrogen atmosphere for 30 minutes and methanol was evaporated to obtain white solid, followed by dehydration at 60° C. for 2 hours. 4.45 g of a DMC catalyst (H⁺[ZnCl]⁺₂[Co(CN)₆]³⁻[CH₃OH]) was obtained. In this case, 1.9 equivalent of hydrochloric acid per cobalt was produced, and a separate extraction process using diethyl ether may not be needed, unlike the case of using 3 equivalent of zinc chloride as the metal salt.

[Example 3] Preparation 2 of DMC Catalyst from H₃Co(CN)₆

Example 3 is the same as the Example 2 above, but 3 equivalent of zinc chloride was used as the metal salt. In this case, hydrochloric acid and methanol produced by reacting the 3 equivalent of zinc chloride and H₃Co(CN)₆.0.5H₂O prepared by the Example 1 above in the presence of methanol were allowed to be removed in vacuum by cold trap. Then, it was confirmed from titration by NaOH standard solution that 1.9 equivalent of hydrochloric acid per cobalt was merely produced.

When the solid residue was washed by diethyl ether, 1 equivalent of zinc chloride was present in diethyl ether.

### [Example 4] Preparation of Propylene Oxide/Carbon Dioxide Copolymer

5 mg of the DMC catalyst prepared by the Example 2 above, 10 g(170 mmol) of propylene oxide, and a chain transfer agent were stirred by a magnetic bar in a 50 ml of microreactor. Carbon dioxide gas was pressurized at T_{R} temperature, the reactor was immersed in an oil bath maintained at a desirable temperature. After the induction time elapsed, the pressure began to be decreased. The polymerization continued until the pressure was decreased up to 3 to 4 bar. When 7 g of polymer was produced due to a stirring problem, the maximum pressure drop was 4 bar, and the reactor after polymerization was cooled by ice bath and CO₂ gas was discharged from the reactor. All volatile materials were evaporated by the rotary evaporator, and the produced polymer was kept in a vacuum oven at 80° C. to completely remove propylene carbonate.

Table 1 shows results obtained by reacting propylene oxide and carbon dioxide in the presence of the double metal cyanide (DMC) catalyst prepared by the Examples 1 and 2 above without the chain transfer agent. In the copolymerization of propylene oxide/carbon dioxide, a significantly high activity together with short induction time (1 hour including heating time) was shown. 5.9 g of polymer was prepared by copolymerization performed under conditions of 90° [symbol] 30 bar CO₂, 5 mg of the double metal cyanide (DMC) catalyst for 1 hour. In addition, the polymer prepared by the copolymerization of propylene oxide/carbon dioxide had a significantly high carbonate content ratio (62 mol %) as compared to the carbonate content ratio (30%) of the polymer prepared in the presence of a general double metal cyanide (DMC) catalyst. Meanwhile, the selectivity was 93%, which is because 7 mol % of propylene carbonate was produced as a subordinate product.

The selectivity, which is a ratio of propylene oxide incorporated into the polymer with respect to the sum of propylene oxide incorporated into the polymer and the propylene carbonate, tended to be increased as temperature was gradually decreased, and was shown up to 98% at 65° C. (see Example 4). Meanwhile, when temperature was decreased, the induction time was increased and the reaction rate was decreased. The carbonate content ratio is an essential temperature-dependent parameter. It was shown that when pressure was increased at a constant temperature of 65° [symbol] the induction time was increased; however, polymerization degree was not affected. As the pressure was increased, the carbonate content ratio was slightly increased.

TABLE 1
Result on Copolymerization of Propylene Oxide/Carbon
Dioxide by H⁺[ZnCl]⁺₂[Co(CN)₆]³⁻[CH₃OH]

| | | | | | | | | Poly- |
|---|---|---|---|---|---|---|---|---|
| | Temper- | | Induction | | Carbonate | | | diversity |
| | ature | Pressure | Time | Yield | Content | | | Index |
| Example | (° C.) | (bar) | (Min) | (g) | Ratio | Selectivity | Mn | (M_{w}/Mₙ) |
| 1 | 90 | 30 | 60 | 5.9 | 0.62 | 0.93 | 41000 | 2.1 |
| 2 | 85 | 30 | 90 | 6.2 | 0.62 | 0.94 | 44000 | 1.9 |
| 3 | 75 | 30 | 135 | 5.7 | 0.63 | 0.95 | 46000 | 2.0 |
| 4 | 65 | 30 | 165 | 4.9 | 0.63 | 0.98 | 46000 | 1.9 |
| 5 | 55 | 30 | 240 | 4.4 | 0.64 | 0.98 | 45000 | 2.0 |
| 6 | 65 | 15 | 90 | 4.0 | 0.57 | 0.97 | 41300 | 1.8 |
| 7 | 65 | 20 | 110 | 4.4 | 0.59 | 0.97 | 40000 | 2.1 |
| 8 | 65 | 25 | 135 | 5.5 | 0.60 | 0.97 | 41000 | 2.2 |
| 9 | 65 | 35 | 200 | 5.9 | 0.66 | 0.97 | 45000 | 2.0 |
| 10 | 65 | 40 | 360 | 6.3 | 0.67 | 0.97 | 44000 | 2.2 |

### [Example 5] Preparation of Poly(Propylene Carbonate-Propylene Oxide)-Diol Using Chain Transfer Agent

In order to obtain poly(propylene carbonate-propylene oxide)-diol having a high carbonate content ratio of about 60 mol % and a low molecular weight, the double metal cyanide (DMC) catalyst (H⁺[ZnCl]⁺₂[Co(CN)₆]³⁻[CH₃OH]) prepared by the Examples 1 and 2 was used, and dicarboxylic acid or diol as a chain transfer agent was introduced into the copolymerization of propylene oxide/carbon dioxide. As shown in Table 2 below, there were differences in yield, polydispersity index, and molecular weight depending on the kind of the chain transfer agent, but the carbonate content ratio was high. In addition, the polydispersity M_{w}/Mₙ thereof had a range of 1.14 to 1.17, and the molecular weight had a distribution of 1400 to 13000.

TABLE 2
Result on Copolymerization of Propylene Oxide/Carbon
Dioxide by H⁺[ZnCl]⁺₂[Co(CN)₆]³⁻[CH₃OH] Under
Supply of Chain Transfer Agent

| | | | | | | | | | Glass |
|---|---|---|---|---|---|---|---|---|---|
| | Chain | | | | | | | Poly- | Transition |
| | Transfer | | Induction | | Carbonate | | | diversity | Temper- |
| | Agent | | Time | Yield | Content | | | Index | ature |
| Example | (mmol) | | (Hr) | (g) | Ratio | Selectivity | Mn | (M_{w}/Mₙ) | (° C.) |
| 1 | CTA 1 | (3.4) | 2 | 4 | 0.6 | 0.84 | 1400 | 1.31 | −36 |
| 2 | CTA 2 | (3.4) | 3 | 5.5 | 0.62 | 0.88 | 2100 | 1.19 | −27.15 |
| 3 | CTA 3 | (3.4) | 3 | 6.3 | 0.6 | 0.90 | 2000 | 1.17 | −32 |
| 4 | CTA 3 | (4.1) | 3 | 6.2 | 0.64 | 0.91 | 1700 | 1.17 | −31 |
| 5 | CTA 3 | (1.7) | 2 | 5.4 | 0.59 | 0.90 | 3700 | 1.25 | −12 |
| 6 | CTA 3 | (0.85) | 1.5 | 5.0 | 0.60 | 0.91 | 7100 | 1.55 | −3 |
| 7 | CTA 3 | (0.43) | 1.5 | 5.8 | 0.60 | 0.93 | 13000 | 1.78 | 1 |
| 8 | CTA 4 | (3.4) | 2 | 6.0 | 0.61 | 0.90 | 2100 | 1.14 | −14 |
| 9 | CTA 4 | (4.1) | 3 | 6.4 | 0.63 | 0.92 | 1600 | 1.17 | −23 |

CTA 1: adipic acid
CTA 2: sebacic acid
CTA 3: 1,10-decandiol
CTA 4: 4,8-bis(hydroxymethyl)tricycle [5.2.1.0^{2,6}]decane

A macro diol structure prepared under the supply of the chain transfer agent was demonstrated by formation of polyurethane. When toluene-2,4-diisocyanide and 1,10-decanediol in an equivalent mole were introduced at 90° [symbol] polyurethane having a number average molecular weight of about 18000 may be formed from a low molecular weight poly(propylene carbonate-propylene oxide)-diol.

### [Comparative Example] Copolymerization of Propylene Oxide/Carbon Dioxide Using Double Metal Cyanide (DMC) Catalyst Prepared by Existing Preparation Method

With t-butanol as a complexing agent, K₃Co(CN)₆ and an excessive amount of zinc chloride were mixed and reacted in the presence of water and the double metal cyanide (DMC) catalyst was prepared by the traditional scheme.

In addition, the copolymerization of propylene oxide/carbon dioxide was performed by using the double metal cyanide (DMC) catalyst prepared by the traditional scheme, except for washing t-butanol. All catalysts showed to have an activity; however, as shown in Table 3 below, the carbonate content ratio was low (18 to 34%) and was decreased as the washing amount was increased. Even in the presence of the chain transfer agent such as an adipic acid, low carbonate content ratio and low selectivity were observed. Reproducibility was deteriorated as much as the molecular weight and the distribution thereof were not constant.

As appreciated by comparing Table 1 with Table 3, in the polymerization by the existing double metal cyanide (DMC) catalyst, change in the carbonate content ratio is significantly sensitive depending on change in CO₂ pressure.

TABLE 3
Result on Propylene Oxide/Carbon Dioxide Copolymer Prepared
From DMC Catalyst Prepared by Traditional Method

| | | | | | Carbonate | | | |
|---|---|---|---|---|---|---|---|---|
| | Chain Transfer | | Induction | Yield | Content | | | Polydiversity |
| Example | Agent (mg) | | Time (Hr) | (g) | Ratio | Selectivity | Mn | Index |
| 1 | 0 | | 2 | 5.5 | 0.34 | 0.91 | 3700 | 4.1 |
| 2 | 0 | | 1.5 | 5.9 | 0.30 | 0.93 | 19500 | 1.6 |
| 3 | 0 | | 1 | 6 | 0.18 | 0.90 | 3600 | 4.5 |
| 4 | CTA 1 | (100) | | ~0 | — | — | — | — |
| 5 | CTA 1 | (100) | 1.5 | 5.9 | 0.36 | 0.76 | 3200 | 2.2 |
| 6 | CTA 1 | (100) | 1 | 3.0 | 0.10 | 0.92 | 3400 | 1.9 |

CTA 1: adipic acid

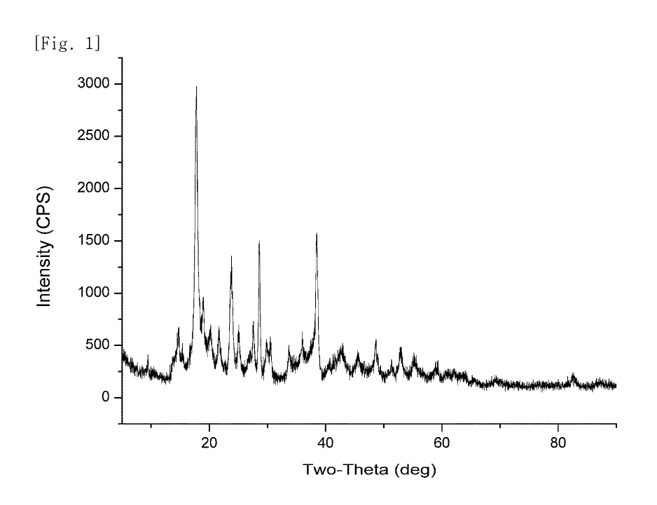

In the double metal cyanide (DMC) catalyst prepared according to the an embodiment of present invention as described above, H₃Co(CN)₆ and the ion-exchange resin rather than K₃Co(CN)₆ are used, such that separate washing processes may be avoided, and water may be minimally incorporated to secure reproducibility as a catalyst. In addition, by removing a centrifuge separator, an embodiment of the present invention provides a method of preparing the double metal cyanide (DMC) catalyst which is more effective and economical in mass-production. It may be appreciated from FIG. 1 that in the double metal cyanide (DMC) catalyst (H⁺[ZnCl]⁺₂[Co(CN)₆]³⁻[CH₃OH]) prepared according to an embodiment of the present invention, an X-ray diffraction pattern shows 20 signal sharp peaks around 17.8, 23.8, 28.6 and 38.5°.

1. A method of preparing a double metal cyanide (DMC) catalyst, the method comprising:
ion-exchanging a metal cyanide complex salt by an ion-exchange resin;
separating the ion-exchanged metal cyanide complex salt;
reacting the separated and ion-exchanged metal cyanide complex salt with a metal salt in the presence of an organic solvent; and
removing the organic solvent by distillation and performing dehydration,
wherein the double metal cyanide (DMC) catalyst is for preparing an epoxide/carbon dioxide copolymer and represented by the following Chemical Formula (1):
H⁺[M(X)]⁺ₙ[M′(CN)₆]^{m-} Chemical Formula (1)
in the Chemical Formula (1), M is a transition metal, X is an anionic salt, H is hydrogen, M′ is any one metal cation selected from the group consisting of Fe(II), Fe(III), Co(II), Co(III), Cr(II), Cr(III), Ni(II), Rh(III), Ru(II), V(IV), and V(V), n is the same as a charge of M, m=n+1 is satisfied, and n and m are non-zero integers.

2. The method of claim 1, wherein the metal cyanide complex salt is represented by the following Chemical Formula (2), and the metal salt is represented by the following Chemical Formula (3):
YₐM′(CN)_{b}(A)_{c} Chemical Formula (2)
in the Chemical Formula (2), M′ is any one metal cation selected from the group consisting of Fe(II), Fe(III), Co(II), Co(III), Cr(II), Cr(III), Ni(II), Rh(III), Ru(II), V(IV), and V(V), Y is an alkali metal ion or alkaline earth metal ion, A is an anionic salt, both of a and b are an integer of 1 or more, and the sum of charges of a, b, and c is the same as a charge of M′, and
M(X)ₙ Chemical Formula (3)
in the Chemical Formula (3), M is a transition metal, X is an anionic salt, and n is an integer as the same as a charge of M.

3. The method of claim 2, wherein X is any one selected from the group consisting of chloride, bromide, iodide, hydroxide, sulfate, carbonate, cyanide, oxalate, thiocyanate, isothiocyanate, carboxylate, and nitrate.

4. The method of claim 2, wherein the metal cyanide complex salt is potassium hexacyanocobaltate (III), and the metal salt is zinc chloride (II), zinc chloride (III), zinc bromide, or zinc iodide.

5. A method of preparing an epoxide/carbon dioxide copolymer comprising: reacting epoxide and carbon dioxide in the presence of the double metal cyanide (DMC) catalyst prepared by the method of claim 1.

6. The method of claim 5, wherein the epoxide/carbon dioxide copolymer has a number average molecular weight of 500 to 500,000, and a carbonate molar ratio of 0.05 to 0.70.

7. The method of claim 5, further comprising: containing a chain transfer agent in the epoxide and the carbon dioxide to react with each other.

8. The method of claim 6, wherein the number average molecular weight is 500 to 200,000.

9. The method of claim 7, wherein the chain transfer agent includes a compound represented by the following Chemical Formula (4):
J(LH)_{d} Chemical Formula (4)
in the Chemical Formula (4), J is C₁ to C₆₀ hydrocarbyl with or without an ether group, an ester group, or an amine group; L is —O or —CO₂; d is an integer of 1 to 10; and when d is 2 or more, L is the same as each other or different from each other.

10. The method of claim 9, wherein d is 2 and J is represented by —(CH)ₙ— or 4,8-bis(hydroxymethyl)tricyclo[5.2.1.0]decane (wherein n is an integer of 1 to 20).

11. An epoxide/carbon dioxide copolymer having a number average molecular weight of 40,000 to 80,000, and a carbonate molar ratio of 0.50 to 0.70, prepared by reacting epoxide and carbon dioxide in the presence of the double metal cyanide (DMC) catalyst prepared by the method of claim 1.

12. The epoxide/carbon dioxide copolymer of claim 11, prepared by containing a chain transfer agent in the epoxide and the carbon dioxide to react with each other, wherein a number average molecular weight is 1,400 to 13,000, and a carbonate molar ratio is 0.50 to 0.70.

13. The method of claim 6, further comprising: containing a chain transfer agent in the epoxide and the carbon dioxide to react with each other.
